(19) United States
(12) Patent Application Publication
(10) Pub. No.: US 2010/0238076 A1
(43) Pub. Date: Sep. 23, 2010

(54) PRINTED ANTENNA WITH IMPROVED MOUNTING STRUCTURE AND ELECTRONIC APPARATUS USING THE SAME

(75) Inventors: CHANG-CHING LIN, Tu-Cheng (TW); JOHN CHOW, Saratoga, CA (US); YUN-CHENG HOU, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/725,470

(22) Filed: Mar. 17, 2010

(30) Foreign Application Priority Data
Mar. 17, 2009 (TW) 98108578

(51) Int. Cl. H01Q 9/04; H01Q 1/24

(52) U.S. Cl. 343/702; 343/700 MS

(57) ABSTRACT

An electronic apparatus includes a main circuit board and a printed antenna secured to the main circuit board. The main circuit board has a grounding trace and a feed trace. The printed antenna includes an insulative base having a number of conductive traces deposited thereon in order to form a grounding portion and a radiating portion separated from each other. The grounding and the radiating portions have first and second conductive pads electrically and mechanically connecting the grounding trace and the feed trace, respectively. As a result, traditional coaxial cables used for connecting the printed antenna and the main circuit board are omitted.

### BACKGROUND OF THE INVENTION

1. Field of the Invention

The present invention relates to a printed antenna and an electronic apparatus with such printed antenna, and more particularly, to a printed antenna with improved mounting structure and an electronic apparatus having such printed antenna featured with a simplified and robust configuration benefiting cost-effective assembly process.

2. Description of Related Art

Electronic devices, such as computers and PDAs, are usually provided with wireless antennas for receiving/transmitting electromagnetic waves in order to meet increasing wireless communication demands. U.S. Pat. No. 6,507,322 issued to Fang et al. on Jan. 14, 2003 discloses such electronic device with such antenna. The electronic device includes a shell, a main board, a pair of slot antennas and a pair of coaxial cables for connecting the slot antennas and the main board. However, with the electronic device becoming more and more smaller, the inner space thereof used for mounting the slot antennas is limited. Besides, since the coaxial cables are dispersedly arranged in the inner space, the organization of the coaxial cables is a problem, which will decrease assembly efficiency of the slot antenna and the main board.

Hence, an improved electronic apparatus and a printed antenna thereof with simple structure for easily assembly are needed to solve the above problems.

### BRIEF SUMMARY OF THE INVENTION

The present invention provides an electronic apparatus including a main circuit board and a printed antenna secured to the main circuit board. The main circuit board includes a grounding trace and a feed trace. The printed antenna includes an insulative base having a plurality of conductive traces deposited thereon in order to form a grounding portion and a radiating portion separated from each other. The grounding and the radiating portions have first and second conductive pads electrically and mechanically connecting the grounding trace and the feed trace, respectively. As a result, transitional coaxial cables used for connecting the printed antenna and the main circuit board are omitted. The difficulty and cost of mounting the printed antenna to the main circuit board are decreased.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an exploded view of an electronic apparatus with a printed antenna separated from a main circuit board in accordance with an embodiment of the present invention;

FIG. 2 is a perspective view of the electronic apparatus as shown in FIG. 1 with the printed antenna mounted to the main circuit board;

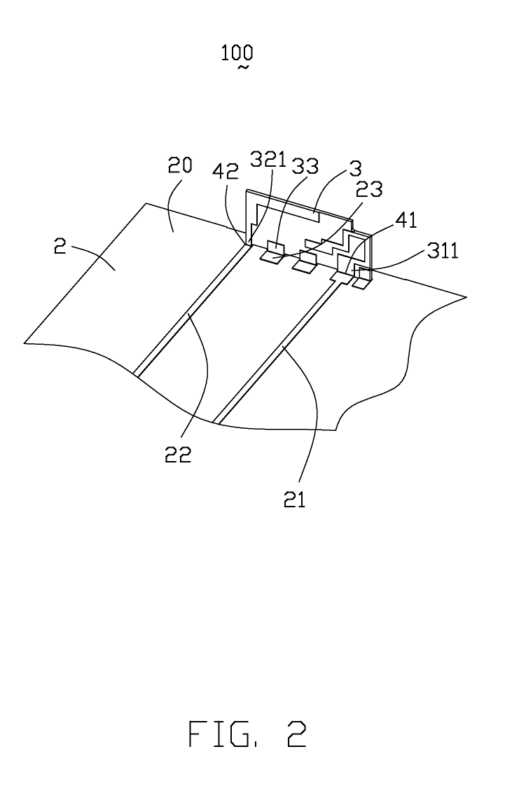

FIG. 3 is a horizontal polarization view showing characteristics of the printed antenna working at frequency of 2.4 GHz; and

FIG. 4 is a vertical polarization view showing characteristics of the printed antenna working at frequency of 2.4 GHz.

### DETAILED DESCRIPTION OF THE PREFERRED EMBODIMENT

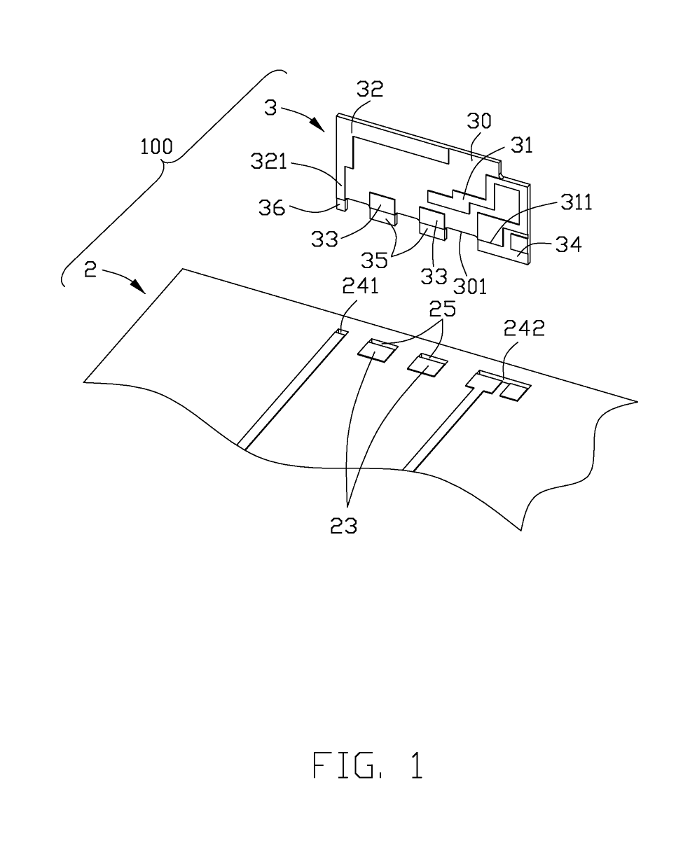

Reference will now be made to the drawing figures to describe the preferred embodiment of the present invention in detail. FIGS. 1&2 illustrate an electronic apparatus 100 such as a notebook computer, a PDA etc. The electronic apparatus 100 includes a main circuit board 2 and a printed antenna 3 mounted to the main circuit board 2. In order to simplify the electronic apparatus 100, other parts thereof are omitted.

The main circuit board 2 is a printed circuit board and includes an insulative base 20 and a plurality of conductive layers deposited on the insulative base in order to form a grounding trace 22 and a feed trace 21. First and second holes 241, 242 are defined through the main circuit board 2 near an outer edge of the main circuit board 2. The feed trace 21 and the grounding trace 22 are terminated at the first and the second holes 241, 242, respectively. Besides, the main circuit board 2 includes a pair of mounting holes 25 and a pair of soldering sections 23 communicating with the pair of mounting holes 25, respectively. The pair of soldering sections 23 are located between the first and the second holes 241, 242 for positioning the printed antenna 3.

The printed antenna 3 is formed by a printed circuit board as well and includes an insulative base 30, a plurality of conductive traces deposited on the insulative base 30 in order to form a grounding portion 32 and a radiating portion 31 separated from each other, and first and second protrusions 36, 34 at or extending downwardly beyond a mounting edge 301 of the insulative base 30 for being inserted into the main circuit board 2. The grounding portion 32 includes a first conductive pad 321 terminated at the mounting edge 301 and downwardly connecting the first protrusion 36. The radiating portion 31 includes a second conductive pad 311 terminated at the mounting edge 301 and downwardly connecting the second protrusion 34. The second conductive pad 311 is wider than the first conductive pad 321 in order to enhance robust characteristics of the printed antenna 3. Besides, the insulative base 30 includes a pair of position blocks 35 disposed between the first and the second protrusions 36, 34, and a pair of soldering pads 33 adjacent to the position blocks 35. The pair of position blocks 35 extend downwardly beyond the mounting edge 301 for being inserted into the mounting holes 25 of the main circuit board 2.

In assembly, the printed antenna 3 is stably mounted to the main circuit board 2 with the first and the second protrusions 36, 34 inserted into the corresponding first and the second holes 241, 242. The first conductive pad 321 touches the grounding trace 22 so that the grounding portion 32 connects the grounding trace 22. A ground point 42 is formed at a cross section of the grounding portion 32 and the grounding trace 22. Additionally, the first conductive pad 321 can be directly soldered with the grounding trace 22 for better electrical and mechanical connection. The second conductive pad 311 touches the feed trace 21 so that the radiating portion 31 connects the feed trace 21. A feed point 41 is formed at a cross section of the radiating portion 31 and the feed trace 21. Additionally, the second conductive pad 311 can be directly soldered with the feed trace 21 for better electrical and mechanical connection as well. Traditional coaxial cables used as feed lines thus are not needed. As a result, mounting of the printed antenna 3 to the main circuit board 2 is eased and accordingly assembly cost is saved.

Besides, the pair of position blocks 35 are inserted into the corresponding mounting holes 25 of the main circuit board 2 for helping fixation of the printed antenna 3. However, the soldering pads 33 can be directly soldered with the soldering sections 23 for better fixation and connection. After assembly, the printed antenna 3 is arranged at an angle with respect to the main circuit board 2. According to the embodiment of the present invention, the printed antenna 3 is vertically mounted to the main circuit board 2.

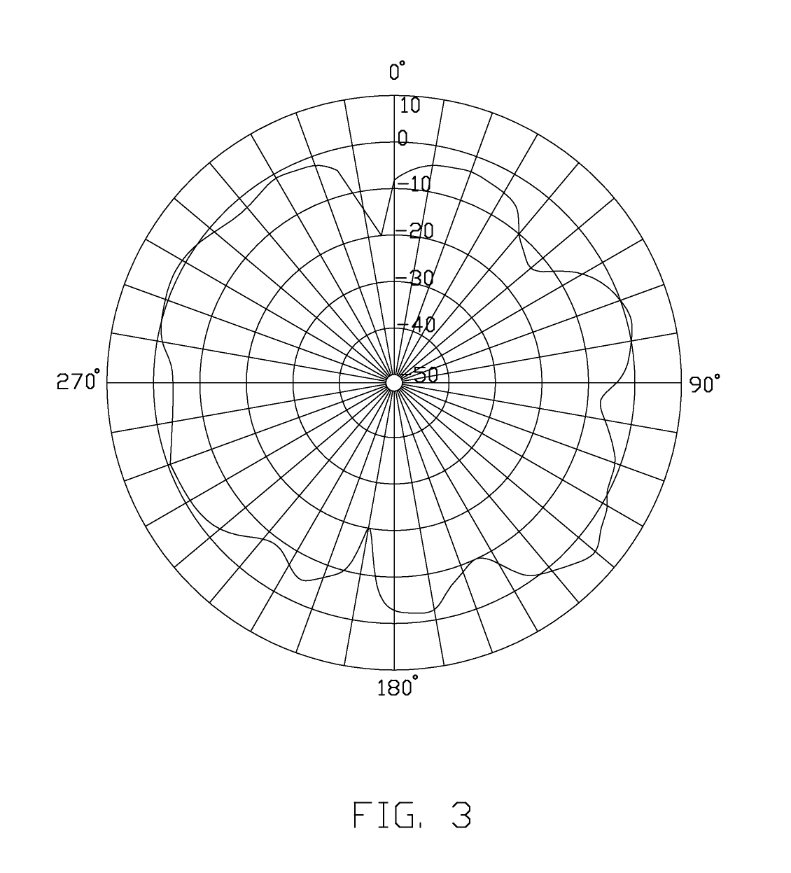

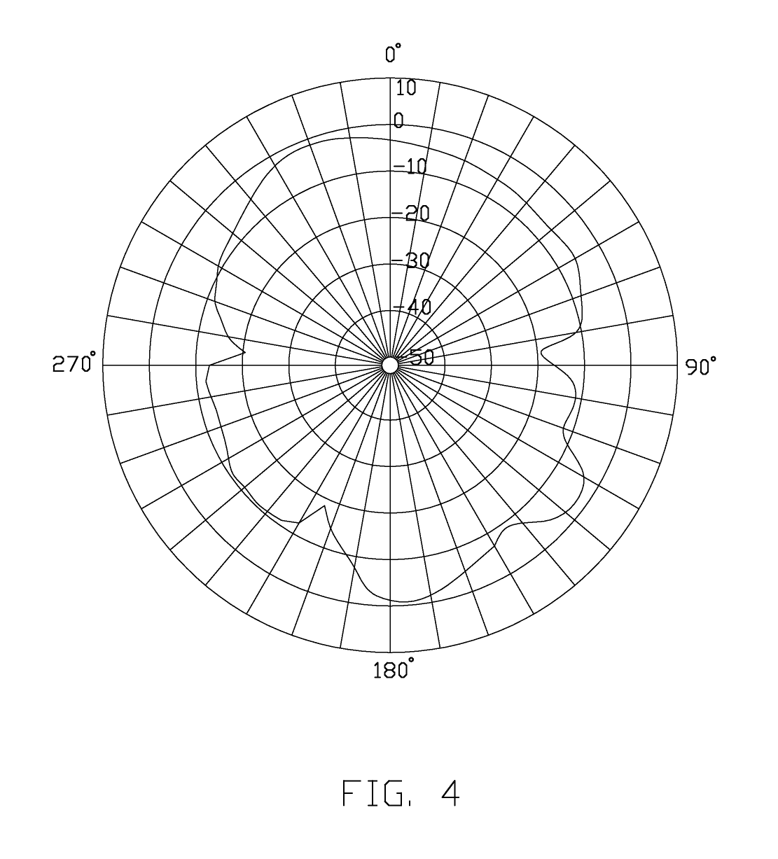

FIGS. 3 and 4 are horizontal and vertical polarization views showing characteristics of the electronic apparatus 100 when the printed antenna 3 is mounted to the main circuit board 2. According to the embodiment of the present invention, the printed antenna 3 is a monopole antenna and its working frequency is 2.4 GHz. Alternatively, the printed antenna 3 can be a multi-band antenna and its working frequency can be adjusted by the profile and the dimension of the radiating portion 31 and the grounding portion 32.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A printed antenna for being mounted to a main circuit board, comprising:
an insulative base having a mounting edge for being mounted to the main circuit board; and
a grounding portion and a radiating portion formed on the insulative base and separated from each other, the grounding portion and the radiating portion having first and second conductive pads adjacent to the mounting edge, respectively.

2. The printed antenna as claimed in claim 1, wherein the first and the second conductive pads are terminated at the mounting edge.

3. The printed antenna as claimed in claim 1, wherein the second conductive pad is wider than the first conductive pad.

4. The printed antenna as claimed in claim 1, wherein the first and the second conductive pads are directly soldered to the main circuit board.

5. The printed antenna as claimed in claim 1, wherein the insulative base comprises first and second protrusions extending beyond the mounting edge for being inserted into the main circuit board.

6. The printed antenna as claimed in claim 5, further comprising at least one position block disposed between the first and the second protrusions, the position block extending downwardly beyond the mounting edge for being inserted into a mounting hole of the main circuit board.

7. An electronic apparatus comprising:
a main circuit board having a grounding trace and a feed trace; and
a printed antenna secured to the main circuit board and comprising an insulative base having a grounding portion and a radiating portion separated from each other, the grounding portion and the radiating portion having first and second conductive pads electrically and mechanically connecting the grounding trace and the feed trace, respectively.

8. The electronic apparatus as claimed in claim 7, wherein a feed point is formed at a junction of the radiating portion and the feed trace, and a grounding point is formed at a junction section of the grounding portion and the grounding trace.

9. The electronic apparatus as claimed in claim 7, wherein the first and the second conductive pads are directly soldered with the grounding trace and the feed trace, respectively.

10. The electronic apparatus as claimed in claim 7, wherein the grounding trace and the feed trace are respectively terminated at first and second holes which are defined in the main circuit board, the insulative base having first and second protrusions inserted into the first and the second holes, respectively.

11. The electronic apparatus as claimed in claim 10, wherein the main circuit board defines a mounting hole between the first and the second holes, and the printed antenna comprises a position block inserted into the mounting hole.

12. The electronic apparatus as claimed in claim 11, wherein the main circuit board comprises a soldering section connecting the mounting hole, and the printed antenna comprises a soldering pad soldered with the soldering section.

13. The electronic apparatus as claimed in claim 10, wherein the printed antenna is mounted to the main circuit board at an angle.

14. The electronic apparatus as claimed in claim 13, wherein the printed antenna is vertically mounted to the main circuit board.

15. The electronic apparatus as claimed in claim 7, wherein the printed antenna is a monopole antenna and its working frequency is 2.4 GHz.

16. The electronic apparatus as claimed in claim 7, wherein the printed antenna is a multi-band antenna.

17. An electronic apparatus comprising:
a main circuit board defining thereon a grounding trace and a radiating trace spaced from each other, and first and second slots formed therein; and
a planar printed antenna including an insulative base defining first and second protrusions on one edge to be respectively received in said first slot and said second slot so as to have said insulative base mounted to said main circuit board in an intersectional manner; wherein
said planar printed antenna includes a radiating portion mechanically and electrically connected to the radiating trace.

18. The electronic apparatus as claimed in claim 17, wherein said first slot and said second slot are spaced and isolated from each other, and said first protrusion and said second protrusion are spaced and separated from each other.

19. The electronic apparatus as claimed in claim 18, wherein the radiating portion is terminated at the first protrusion, and the radiating trace is terminated at the first slot to connect to said radiating portion.

20. The electronic apparatus as claimed in claim 17, wherein said printed antenna further includes a grounding portion terminated at the second protrusion, and the grounding trace is terminated at the second slot to connect to said grounding portion.
